(19) United States
(12) Patent Application Publication
(10) Pub. No.: US 2004/0256875 A1
(43) Pub. Date: Dec. 23, 2004

(54) Luggage loft assembly and installation method

(76) Inventor: Alvin D. McCauley, Holly, MI (US)

Correspondence Address: REISING, ETHINGTON, BARNES, KISSELLE, P.C., P O BOX 4390, TROY, MI, 48099-4390, US

(21) Appl. No.: 10/769,453

(22) Filed: Jan. 30, 2004

Related U.S. Application Data
(60) Provisional application No. 60/443,685, filed on Jan. 30, 2003.

(51) Int. Cl. B60R 7/00

(52) U.S. Cl. 296/37.7

(57) ABSTRACT

A luggage loft assembly and installation method for supporting articles over the seating area of a mass transit vehicle passenger compartment. The assembly includes a rack configured to carry objects for storage and at least two spaced-apart generally parallel inboard stanchions connected at respective lower ends to an inboard side of the rack. At least two spaced-apart generally parallel outboard stanchions are connected at respective inboard ends to an outboard side of the rack. The rack comprises at least two spaced-apart generally parallel support arms and a plurality of generally parallel spaced-apart rails carried by the support arms. The outboard stanchions have respective outboard ends connectable to a vehicle structure such as a wall. The inboard stanchions have respective upper ends that are connectable to a vehicle ceiling. The rack and stanchions are pre-assembled and positioned in a vehicle as a unit and the stanchions are then connected to an interior of the vehicle.

### CROSS-REFERENCES TO RELATED APPLICATIONS

This application claims priority from Provisional Application No. 60/443,685, filed Jan. 30, 2003 and entitled “Luggage Loft”, which is incorporated by reference.

### STATEMENT REGARDING FEDERALLY SPONSORED RESEARCH OR DEVELOPMENT

Not Applicable

### BACKGROUND OF THE INVENTION

1. Field of the Invention

This invention relates generally to a luggage loft assembly and installation method for supporting articles over the seating area of a mass transit vehicle passenger compartment.

2. Description of the Related Art Including Information Disclosed Under 37 CFR 1.97 And 1.98

Luggage loft assemblies for supporting articles over the seating area of a mass transit vehicle passenger compartment are well known and in common use. For example, U.S. Pat. No. 5,441,326 issued to Mikalonis on Aug. 15, 1995 and assigned to Transmatic, Inc., discloses a luggage loft assembly for use in a mass transit vehicle and including a rack comprising a plurality of plastic loft panels. The loft panels are supported along respective outboard edges by being attached to an interior side wall of the vehicle. Each loft panel includes an elongated hooked or bent section formed along its outboard edge and a sheet of wood molded into the panel for structural stiffness. An elongated U-shaped bracket is fixed horizontally along the interior sidewall of a vehicle that the loft is to be installed in and is configured to receive the hooked sections of the loft panel outboard edges in a roll-in type engagement. The luggage loft assembly of the Mikalonis patent includes a base member supported along the outboard edge of each loft panel. The base member includes an elongated U-shaped recess or channel configured to slidably receive bolt heads. A plurality of spaced inboard stanchions are connected at respective lower ends to bolts whose heads are slidably supported in the base member channel. The luggage loft assembly disclosed in the Mikalonis patent also includes an elongated bracket fixed to the ceiling of the vehicle and configured to be bolted to upper ends of the stanchions to suspend the outboard edges of the loft panels.

In addition, U.S. Pat. No. 6,241,861 issued to Calnon on Jun. 5, 2001 and assigned to Transmatic Europe Limited, discloses a method for installing a luggage loft in a vehicle, which includes first engaging and supporting an outboard edge of the loft to a wall of the vehicle by inserting an outer edge of a loft panel into an elongated receiving bracket previously attached to the wall. An inboard edge of the loft is then supported by attaching upper ends of inboard stanchions to ceiling bolts.

U.S. Publication No. US 2002/0030374, which lists Herman Myburgh as inventor and has a publication date of 14 Mar. 2002, discloses a single piece loft rack panel supported along an outboard edge by fastening an upturned portion of the outboard edge of the panel to the vehicle wall. The loft rack panel is supported along an inboard edge by inboard stanchions.

### BRIEF SUMMARY OF THE INVENTION

The invention is a luggage loft assembly for supporting articles over the seating area of a mass transit vehicle passenger compartment. The assembly includes a rack configured to carry objects for storage. The rack is supportable along an outboard edge of the rack on a vehicle wall and along an inboard edge of the rack by at least two spaced-apart generally parallel generally vertical inboard stanchions. The inboard stanchions are connected at respective inboard stanchion lower ends to an inboard side of the rack and have respective upper ends that are connectable to a vehicle ceiling. The luggage loft assembly and installation method also includes at least two spaced-apart generally parallel outboard stanchions connected at respective outboard stanchion inboard ends to an outboard side of the rack, the outboard stanchions having respective outboard ends connectable to a vehicle structure such as a wall, a cornice lighting fixture, or an air conditioning duct panel.

Unlike the prior art, the luggage loft assembly also includes two spaced-apart generally parallel support arms and a plurality of generally parallel spaced-apart rails carried by the support arms. Because the rails are spaced-apart, the contents of the loft can be viewed from below. This allows passengers and bus operators to easily determine whether passengers have left articles behind on the loft. This arrangement also improves the circulation of air through the passenger compartment and allows the loft to flex torsionally with a host vehicle.

According to another aspect of the invention, the rails are cylindrical or rod-shaped.

According to another aspect of the invention, the rails are tubular with hollow cores to reduce weight.

According to another aspect of the invention, the rails are made of fiberglass.

According to another aspect of the invention, the inboard and outboard rails are out of plane above the intermediate rails between them to prevent articles from sliding laterally off the rack.

According to another aspect of the invention, the inboard and outboard rails are extruded aluminum tubes because aluminum is lightweight and can be colored to match or complement the color of the support arms.

According to another aspect of the invention, the support arms include a plurality of rail receptacles in the form of through-holes formed laterally through the arms. The receptacles are shaped to receive the rails and position the rails relative to one another.

According to another aspect of the invention, each support arm comprises forward and aft interconnecting elongated panels, and each panel includes a plurality of apertures positioned to align with each other and form a plurality of rail receptacles spaced along respective lengths of the support arms when the forward and aft support arm panels are interconnected.

According to another aspect of the invention, the forward and aft panels of at least one of the support arms includes and inboard and an outboard recess configured and positioned to receive an inboard and an outboard stanchion, respectively.

According to another aspect of the invention, at least one of the rails includes an anti-rotation through hole at a position along the length of the at least one rail where a support arm is to be located. An anti-rotation pin is disposed through the anti-rotation hole, the pin having a length greater than the length of the anti-rotation hole so that at least one end of the pin extends outward from the rail in a generally radial direction. An anti-rotation recess is formed in an aft end of a sleeve defining one of the apertures in the forward panel of at least one support arm, the recess being shaped to receive and retain an outwardly extending portion of the anti-rotation pin. An outwardly extending portion of the anti-rotation pin is engaged in the anti-rotation recess to prevent the rail from rotating about its longitudinal axis relative to the support arm.

According to another aspect of the invention, each support arm forward panel includes a front panel and a peripheral wall extending aft from around a periphery of the front panel. Each support arm aft panel includes a back panel and a peripheral wall extending aft from around a periphery of the back panel. An aft edge of the forward panel peripheral wall and a forward edge of the aft panel peripheral wall are configured to interlock so as to hold the edges of the walls in flush abutment and form a uniform seam between them.

According to another aspect of the invention, the aft edge of the forward panel peripheral wall includes a beveled inner lip and the forward edge of the aft panel peripheral wall includes a beveled outer lip positioned to slide outside the beveled inner lip of the forward panel peripheral wall.

According to another aspect of the invention, the rack includes an end arm comprising one of a forward or an aft support arm panel having apertures engaged on respective distal ends of the rails. An end panel is fastened across the support arm panel.

According to another aspect of the invention, the inboard stanchion lower ends are connected to respective support arm inboard ends.

According to another aspect of the invention, each inboard stanchion includes an engagement key having an inverted T-shape and extending integrally axially downwardly from the lower end of each stanchion. Each elongated key is slidably retained in an elongated keyway recess formed in the inboard rail. The keyway has a cross section complementary to that of the engagement key so inboard stanchions can be connected to the inboard rail by sliding the elongated keyway recess of the inboard rail over the engagement key of each inboard stanchion.

According to another aspect of the invention, the support arms each include an inboard stanchion receptacle in the form of a through hole formed vertically through the inboard end of each arm and intersecting an inboard rail receptacle to form a receptacle intersection. Each inboard stanchion receptacle is shaped to receive a lower end of each inboard stanchion so that a joint formed by the connection of each inboard stanchion to the inboard rail is housed within the receptacle intersection.

According to another aspect of the invention, the outboard stanchions are disposed in a generally horizontal orientation and the outboard ends of the outboard stanchions are connectable to a wall of the vehicle.

According to another aspect of the invention, each outboard stanchion includes an engagement key having an inverted T-shape and extending integrally and axially from the inboard end of each stanchion. Each elongated key is slidably retained in an elongated keyway recess formed in the inboard rail and having a cross section complementary to that of the engagement key. This allows the outboard stanchions to be connected to the outboard rail by sliding the elongated keyway recess of the outboard rail over the engagement key of each stanchion. It also allows the outboard stanchions to be slid along the outboard rail to advantageous positions that allow them to be attached to a vehicle wall or other structure.

According to another aspect of the invention, the loft includes diagonal stanchions connected at respective inboard ends to the outboard end of the rack and disposed in a generally diagonal orientation relative to the inboard stanchions. The diagonal stanchions have outboard ends connectable to a vehicle wall to further brace the loft.

According to another aspect of the invention, the outboard stanchions are connectable at their outboard ends to a cornice-mounted interior lighting fixture supported in a vehicle passenger compartment.

According to another aspect of the invention, the outboard stanchions are connectable at their outboard ends to a portion of the cornice lighting fixture disposed outboard of a lamp of the lighting fixture.

According to another aspect of the invention, the outboard stanchions are connectable at their outboard ends to a portion of the cornice lighting fixture disposed inboard of a lamp of the lighting fixture.

According to another aspect of the invention, the loft includes receptacles configured to receive respective upper ends of the inboard stanchions and outboard ends of the outboard stanchions. Each receptacle is configured to attach to a surface of a vehicle interior and includes a pair of diametrically opposed receptacle holes formed through opposite walls of the receptacle. Each stanchion includes a pair of diametrically opposed stanchion holes formed through the upper end of each stanchion. The stanchion holes are configured to align with the receptacle holes when a stanchion is pushed into a receptacle, the stanchion and receptacle holes being configured to receive the shaft of a fastener when so aligned.

According to another aspect of the invention, the inboard rail is elevated farther above the plain of the intermediate rails than is the outboard rail to provide added protection against articles falling over the inboard side of the rack.

According to another aspect of the invention, the rails are spaced far enough apart to allow standard sized cans and bottles to fall through so that passengers are prevented from disposing of empty cans and bottles by depositing them in the loft.

According to another aspect of the invention, the assembly includes an elongated lamp module supportable on any two adjacent rails of the assembly and including at least one downwardly-directed lamp.

According to another aspect of the invention, each lamp module includes a base panel supporting the at least one lamp, and a top panel supporting the base panel and configured to engage and support the lamp module from two adjacent rails of the assembly.

According to another aspect of the invention, the top panel is formed to include two rail retainers configured to snap onto adjacent rails of the luggage loft assembly.

The invention also includes a method for making and installing a luggage loft that includes a rack, at least two inboard stanchions connectable at respective lower ends to an inboard side of the rack and at respective upper ends to a vehicle ceiling, and at least two outboard stanchions connectable at respective inboard ends to an outboard side of the rack and at respective outboard ends to a vehicle structure. The method includes assembling the loft assembly such that the inboard stanchions extend from respective spaced apart locations along an inboard side of the rack and the outboard stanchions extend from respective spaced apart locations along an outboard side of the rack, affixing inboard stanchion receptacles in desired locations along the ceiling of a vehicle, affixing outboard stanchion receptacles in desired locations along a wall or other supporting structure of the vehicle, moving the loft assembly into a desired position for installation within a vehicle, connecting upper ends of the inboard stanchions to the inboard receptacles, and connecting outboard ends of the outboard stanchions to the outboard receptacles.

According to another aspect of the inventive method, the rack may be assembled by providing a plurality of rails and at least two elongated support arms configured to carry the rails, sliding the rails through rail receptacles spaced along respective lengths of the support arms, and spacing the support arms such that the arms are generally parallel to one another and carry the rails in a generally parallel orientation relative to one another and perpendicular relative to the arms. Respective lower ends of at least two inboard stanchions are then attached to an inboard side of the rack and respective inboard ends of at least two outboard stanchions are attached to an outboard side of the rack.

According to another aspect of the inventive method, the step of attaching inboard stanchions includes inserting a keyed end of an inboard stanchion into an inboard stanchion receptacle of one of the support arms that intersects one of the rail receptacles of that support arm such that a key extending from the inboard stanchion is positioned within the longitudinal receptacle, and sliding a rail through the intersecting longitudinal receptacle of the support arm such that a keyway recess formed along the length of the rail receives and slides along the key extending from the inboard stanchion.

According to another aspect of the inventive method, the step of attaching outboard stanchions includes inserting a keyed end of an outboard stanchion into an outboard stanchion receptacle of one of the support arms that intersects one of the rail receptacles of that support arm such that a key extending from the outboard stanchion is positioned within the longitudinal receptacle, and sliding a rail through the intersecting longitudinal receptacle of the support arm such that a keyway recess formed along the length of the rail receives and slides along the key extending from the outboard stanchion.

According to another aspect of the inventive method, the method includes the additional steps of providing a plurality of rails and two elongated support arms configured to carry the rails, each support arm comprising forward and aft interconnecting elongated panels, each panel including a plurality of apertures positioned to align with each other and form a plurality of rail receptacles spaced along respective lengths of the support arms when the forward and aft support arm panels are interconnected; sliding the rails through the apertures of the forward panel of a first one of the support arms; inserting a key integrally extending from an inboard end of one of the outboard stanchions into a complementary keyway recess formed along the length of one of the rails and sliding the outboard stanchion along that rail and into engagement with the forward panel of the first support arm; inserting a key integrally extending from a lower end of one of the inboard stanchions into a complementary keyway recess formed along the length of one of the rails and sliding the inboard stanchion along that rail and into engagement with the forward panel of the first support arm; engaging the apertures of the aft panel of the first support arm on the rails and sliding it along the rails and into engagement with the forward panel of the first support arm such that intersecting portions of the stanchions and rails are enclosed within the first support arm; and connecting the aft panel of the first support arm the forward panel of the first support arm.

According to another aspect of the inventive method, the method includes the additional steps of providing an anti-rotation through hole in one of the rails at a position along the length of that rail where a support arm is to be located; passing an anti-rotation pin through the anti-rotation hole, the pin having a length greater than the length of the anti-rotation hole so that at least one end of the pin extends outward from the rail in a generally radial direction; providing an anti-rotation recess in an aft end of a sleeve defining one of the apertures in the forward panel of the first support arm, the recess being shaped to receive and retain an outwardly extending portion of the anti-rotation pin; and engaging an outwardly extending portion of the anti-rotation pin in the anti-rotation recess during the step of sliding the rails through the apertures of the forward panel of the first support arm to prevent the rail from rotating about its longitudinal axis relative to the support arm.

According to another aspect of the inventive method, the method includes the additional steps of engaging the apertures of the forward panel of a second support arm on the rails, positioning the forward panel of the second support arm at respective distal ends of the rails, positioning an end panel across an aft side of the forward panel, and fastening the end panel to the forward panel.

According to another aspect of the inventive method, before the step of positioning an end panel, the method includes the additional step of inserting an expansion plug into the distal end of one of the rails, the expansion plug having a threaded sleeve embedded in a forward end of an axial hole in the plug, the expansion plug having an outer diameter generally equal to an inner diameter of the rail. After the step of positioning an end panel, a threaded shaft of a fastener is inserted through a hole in the end panel and into the axial hole of the plug, threadedly engaging the fastener with the threaded sleeve of the plug. The fastener is then rotated about its axis such that the threaded sleeve is drawn axially aft, axially compressing the plug and causing radial pressure against an inner wall of the rail.

The invention also includes a method for interconnecting end-to-end a pair of loft assembly racks for a mass transit vehicle passenger compartment where each rack includes a plurality of rails carried by two elongated support arms, each support arm comprises forward and aft interconnecting elongated panels, and each panel includes a plurality of apertures positioned to align with each other and form a plurality of rail receptacles spaced along respective lengths of the support arms when the forward and aft support arm panels are interconnected. This method includes the steps of engaging and positioning the apertures of a support arm forward panel on the aft distal ends of rails of a forward one of the two racks; engaging and positioning the apertures of a support arm aft panel on the forward distal ends of rails of an aft one of the two racks; mounting the forward and aft racks in respective forward and aft positions in a vehicle with the support arm forward panel at the aft end of the forward rack abutting the support arm aft panel at the forward end of the aft rack; and fastening the support arm forward panel at the aft end of the forward rack to the support arm aft panel at the forward end of the aft rack so that the resulting junction of the two racks is concealed within a support arm that, to an observer, appears identical to the other support arms of the two racks.

### BRIEF DESCRIPTION OF THE SEVERAL VIEWS OF THE DRAWINGS

These and other features and advantages of the invention will become apparent to those skilled in the art in connection with the following detailed description and drawings, in which:

FIG. 1 is an end perspective view of four luggage loft assemblies constructed according to the invention, two of which are shown installed in each of two opposite cornice areas of a mass transit vehicle passenger compartment;

FIG. 2 is a top orthogonal view of two of the luggage loft assemblies shown installed on the left side of the vehicle passenger compartment as shown in FIG. 1, the two assemblies being shown before being installed in the passenger compartment and before being joined together, end-to-end;

FIG. 3 is a bottom orthogonal view of one of the two luggage loft assemblies shown in FIG. 2;

FIG. 4 is an end view of one of the luggage loft assemblies of FIG. 2, with a phantom representation of an outboard stanchion of the assembly showing an alternate installation position of the outboard stanchion;

FIG. 5 is an end view of a lamp assembly portion of one of the luggage loft assemblies of FIG. 2;

FIG. 6 is a partial top orthogonal view of one of the luggage loft assemblies of FIG. 2 showing an exploded view of an arm of a rack portion of the assembly;

FIG. 7 is a partial top orthogonal exploded view of joined ends of the two luggage loft assemblies of FIG. 1; and

FIG. 8 is a partial top orthogonal exploded view of one end of one of the luggage loft assemblies of FIG. 1.

### DETAILED DESCRIPTION OF THE INVENTION EMBODIMENT(S)

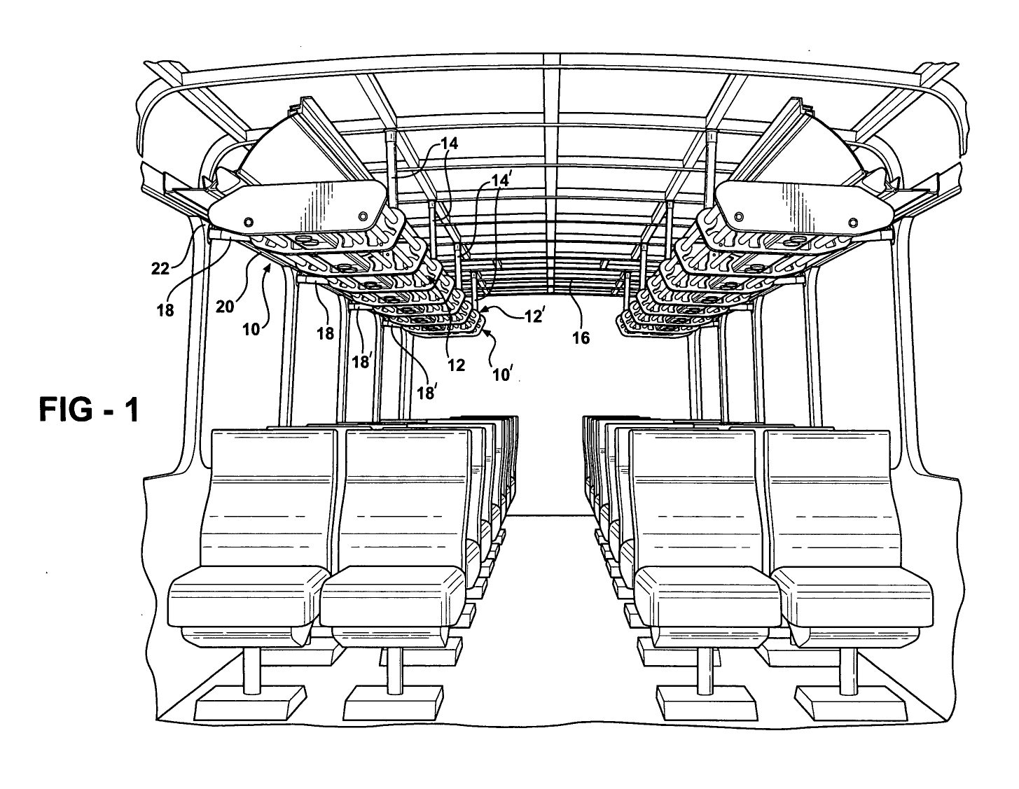

A luggage loft assembly for supporting articles over the seating area of a mass transit vehicle passenger compartment is shown at 10 in the drawings. The assembly 10 includes a rack 12 that carries the objects for storage. Two or more spaced apart generally parallel, generally vertical inboard stanchions 14 are connected at respective inboard stanchion lower ends to an inboard side 15 of the rack 12. The inboard stanchions 14 have respective upper ends connectable to an overhead vehicle support structure such as a ceiling 16 as shown in FIG. 1. The assembly 10 also includes two or more spaced apart generally parallel outboard stanchions 18 connected at respective outboard stanchion inboard ends to an outboard side 20 of the rack 12. The outboard stanchions 18 have respective outboard ends connectable to a vehicle structure such as a wall 22 as shown in FIG. 1, or a cornice lighting fixture or air conditioning duct panel. The rack 12 includes five spaced apart, generally parallel transverse arms 24. The embodiment shown in the drawings includes first and second intermediate support arms 24a, 24b, and a center arm 24c as well as a forward end arm 24d and an aft end arm 24e. The rack 12 also includes a plurality of generally parallel spaced apart longitudinal rails 26 carried by the intermediate support arms 24a, 24b. The center arm 24c and the end arms 24d, 24e secure the rails 26 in their positions relative to one another but do not support the rails 26 from bus structures. The rails 26 include an inboard rail 26a, an outboard rail 26b and a plurality of intermediate rails 26c positioned between the inboard and outboard rails 26a, 26b.

The rails 26 are cylindrical in shape and tubular, their hollow cores serving to reduce the weight of the assembly 10. The arms 24 support the inboard and outboard rails 26a, 26b in an elevated position above a generally horizontal plane defined by the intermediate rails 26c disposed between the inboard and outboard rails 26a, 26b. These intermediate rails 26c are preferably made of fiberglass to further reduce weight, but in other embodiments, may be made of any suitable material. The inboard and outboard rails 26a, 26b are preferably extruded aluminum tubes. These aluminum rails 26a, 26b may be colored to match or complement the color of the arms 24, and/or the intermediate rails 26c. The inboard rail 26a is positioned and designed to serve as a handrail and is constructed to be strong enough to support the full weight of passengers who use the inboard rail 26a for support while standing and/or walking through a vehicle.

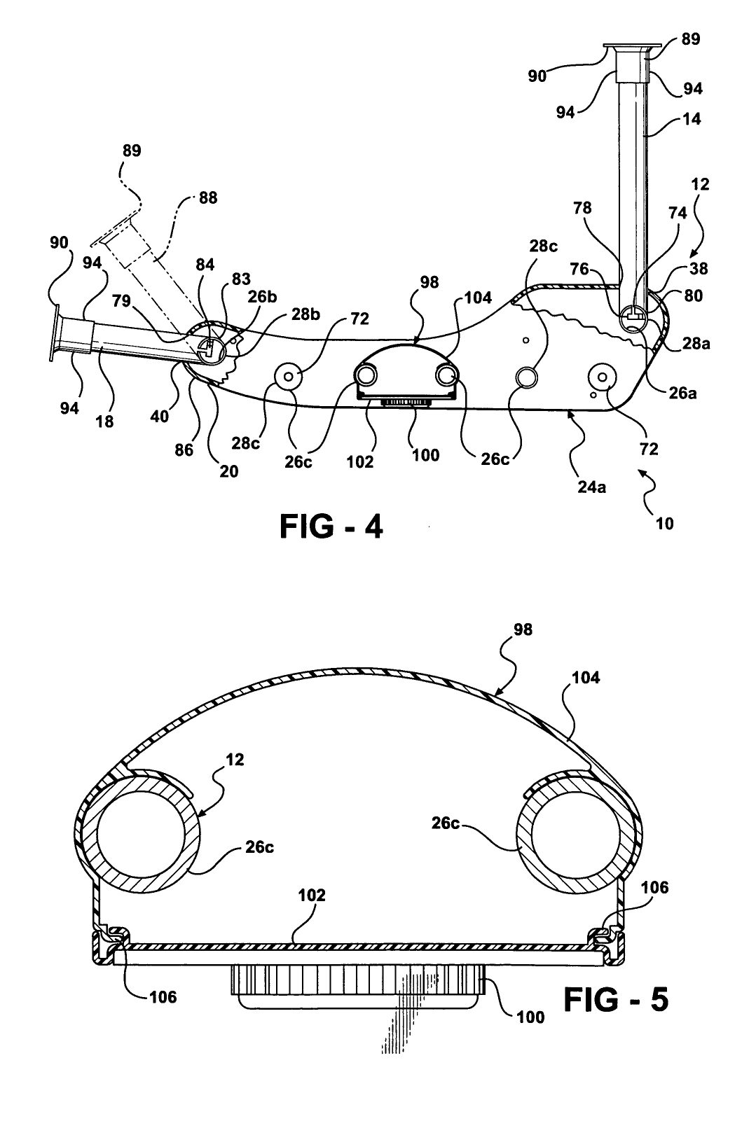

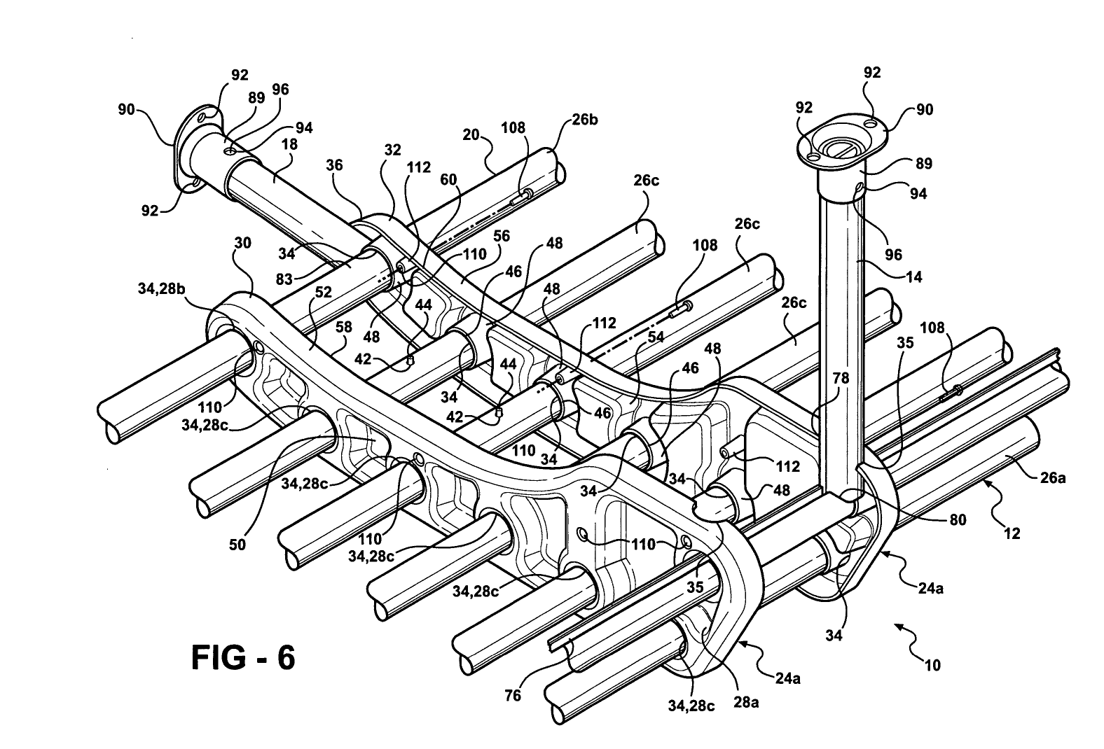

As best shown in FIGS. 4 and 6, each of the intermediate arms 24a, 24b, and the center arm 24c includes a plurality of short, longitudinal, tubular rail receptacles 28 in the form of through-holes formed through each of the arms 24. The rail receptacles 28 are shaped to receive the rails 26 and to hold the rails 26 in their desired relative positions. The rails 26 pass completely through intermediate support arms 24a, 24b and the center arm 24c and terminate at either end in the longitudinal rail receptacles 28 of the two end arms 24d, 24e. The longitudinal rail receptacles 28 include inboard rail receptacles 28a that receive the inboard rail 26a, outboard rail receptacles 28b that receive the outboard rail 26b, and a plurality of intermediate rail receptacles 28c that carry the intermediate rails 26c.

As is best shown in FIG. 6, each of the intermediate support arms 24a, 24b and the center arm 24c comprises forward and aft interconnecting elongated clamshell panels 30, 32, each panel including a plurality of tubular apertures best shown at 34 in FIG. 6. The tubular apertures 34 of the forward panels 30 are positioned to align with corresponding apertures 34 of the aft panels 32 when the forward and aft support arm panels 30, 32 are interconnected. When the forward and aft support arm panels 30, 32 are interconnected the apertures 34 form the plurality of longitudinal rail receptacles 28 that are spaced along respective lengths of the arms 24.

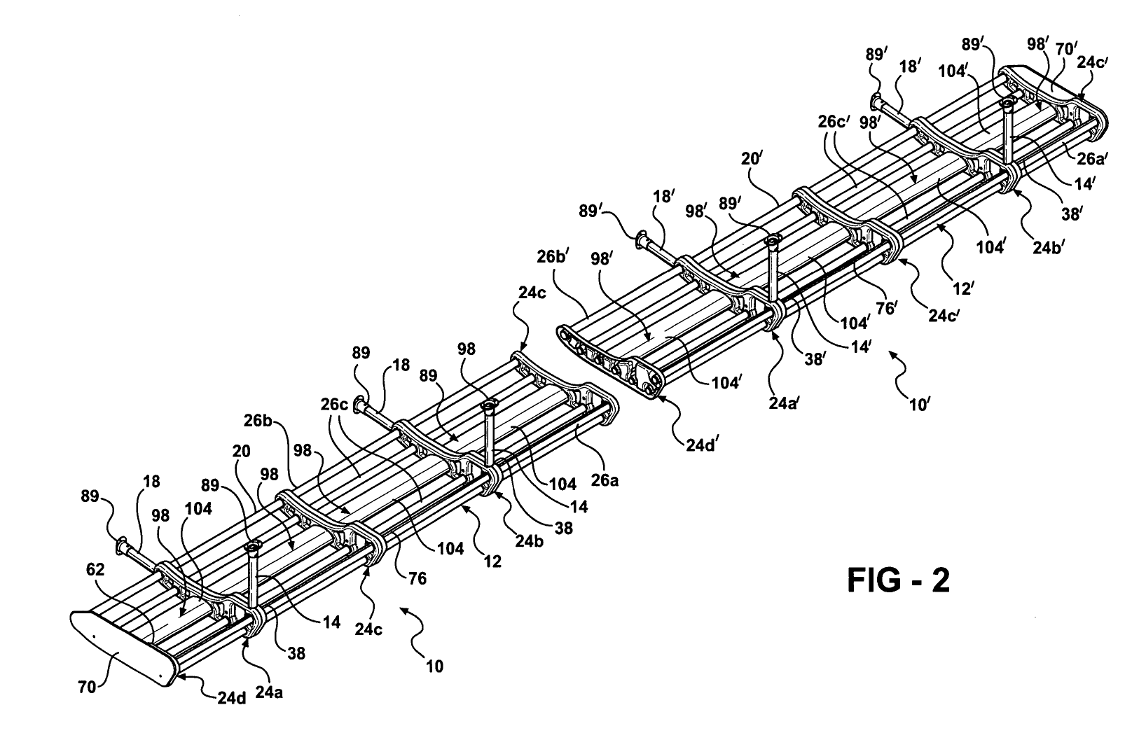

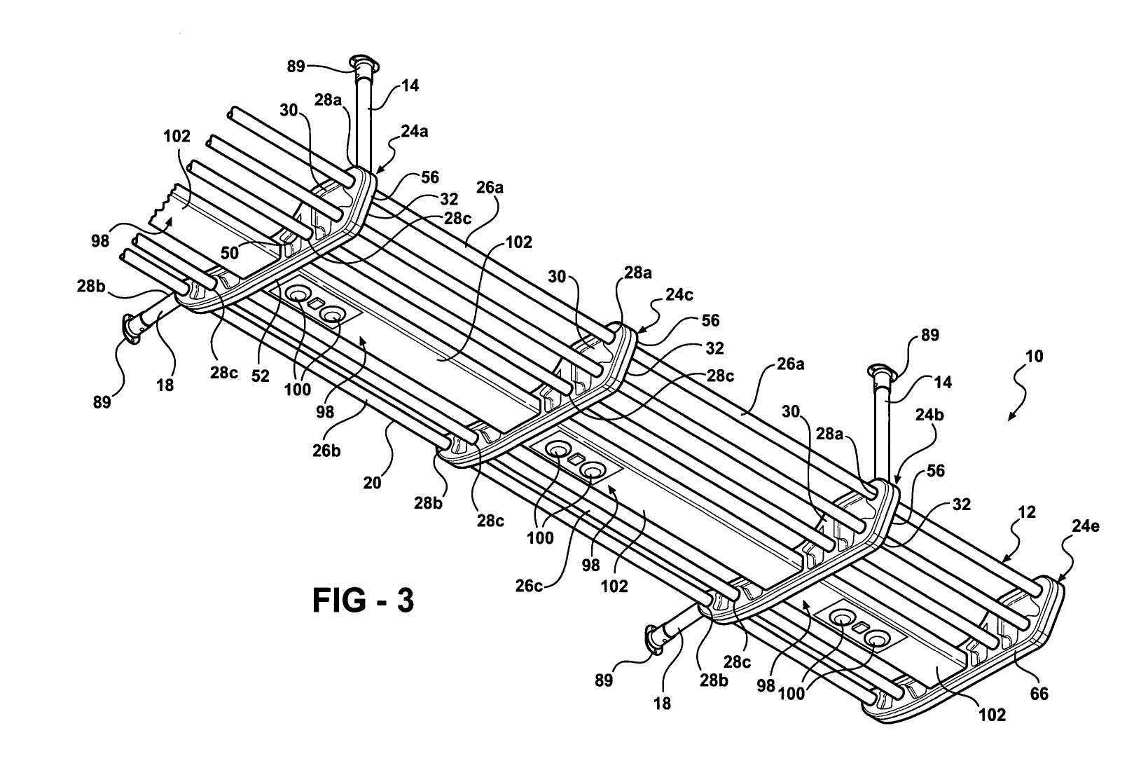

Referring again to FIG. 6, the forward and aft panels 30, 32 of each of the intermediate support arms 24a, 24b include inboard and outboard half-circular recesses 35, 36. As shown in FIGS. 2 and 4, when the forward and aft panels 30, 32 are joined together, the half-circular recesses 35, 36 form inboard and outboard circular stanchion receiving holes 38, 40 that are positioned to receive an inboard stanchion 14 and an outboard stanchion 18, respectively.

As is also shown in FIG. 6, each intermediate rail 26c includes a generally vertical diametrically-oriented anti-rotation through-hole 42 at a position along the length of each intermediate rail 26c where an intermediate support arm 24a, 24b is to be located. Anti-rotation pins 44 are disposed through the anti-rotation holes 42, each pin 44 having a length greater than the length of the anti-rotation hole 42 so that opposite ends of the pin 44 extend outward from the rail 26c in generally radial directions. Two anti-rotation recesses 46 are formed in diametrically opposite upper and lower sides of an aft end of sleeves 48 that define the intermediate tubular apertures 34 in the forward panel of each intermediate support arm 24a, 24b. The anti-rotation recesses 46 are shaped to receive and retain the outwardly extending portions of the anti-rotation pins 44. The outwardly extending portions of the anti-rotation pins 44 are engaged in the anti-rotation recesses 46 to prevent the intermediate rails 26c from rotating about respective longitudinal axes.

Each support arm and center arm forward panel 30 includes a front panel portion 50 and a peripheral wall 52 that extends integrally aft from around a periphery of the front panel 50. Each support arm aft panel 32 includes a back panel portion 54 and a peripheral wall 56 that extends integrally aft from around a periphery of the back panel 54. An aft edge of the forward panel peripheral wall 52 and a forward edge of the aft panel peripheral wall 56 are configured to interlock so as to hold the edges of the walls 52, 56 in flush abutment and to form a uniform seam between them. More specifically, and as best shown in FIG. 6, the aft edge of the forward panel peripheral wall 52 includes a beveled outer lip 58; and the forward edge of the aft panel peripheral wall 52 includes a beveled inner lip 60 positioned to slide inside the beveled outer lip 58 of the forward panel peripheral wall 52.

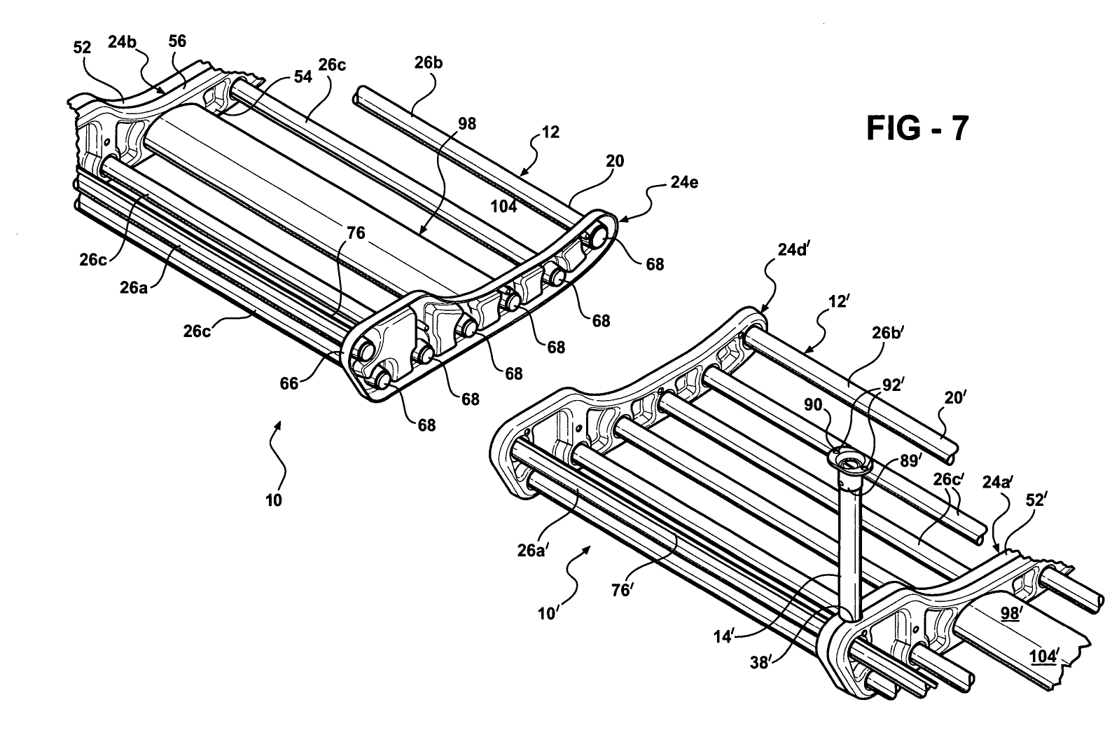

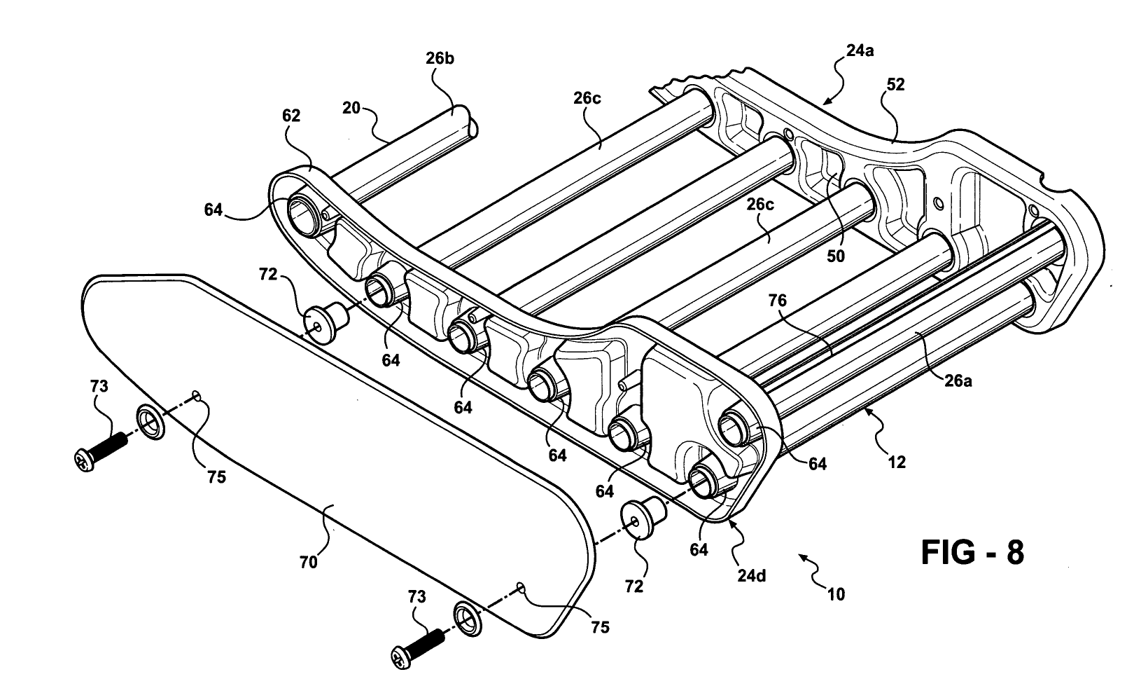

As shown in FIGS. 2 and 8, the forward end arm 24d includes an aft support arm panel 62 having apertures 64 engaged on respective aft distal ends of the rails 26. As shown in FIG. 7, the aft end arm 24e includes a forward support arm panel 66 having apertures 68 engaged on respective forward ends of the rails 26. A flat end panel 70 is fastened across the forward and/or the aft support arm panels 62, 66 of the aft and forward end arms 24e, 24d, respectively, using expansion plugs 72. As shown in FIG. 8, two expansion plugs 72 are inserted into the aft distal ends of two of the intermediate rails 26c. Screws 73 pass through holes 75 in the end panel 70 and into the expansion plugs 72. Two expansion plugs 72 may also be inserted into the forward distal ends of two of the intermediate rails 26c when an end panel is to be affixed to the forward end arm of a luggage loft assembly. As shown in FIG. 2, when two luggage loft assemblies, 10, 10′ are to be mounted end-to-end in a vehicle, flat end panels 70, 70′ will be affixed only to the forward end arm 24d of one assembly 10 and the aft end arm 24e′ of the other assembly 10′. As shown in FIGS. 2 and 7, this allows the aft end arm 24e of one assembly 10 to be connected to the forward end arm 24d′ of the other assembly 10′ as will be described in further detail below.

The lower ends of the inboard stanchions 14 are connected through respective support arm inboard ends to the inboard rail 26a. As shown in FIG. 4, each inboard stanchion 14 includes a T-shaped engagement key 74 that extends integrally and axially from the lower end of each inboard stanchion 14. Each key 74 is slidably retained in an elongated keyway recess 76 formed in the inboard rail 26a at a point along the rail 26a where the inboard rail 26a is disposed within an intermediate support arm 24a, 24b. The keyway 76 has a cross-section complementary to that of the engagement key 74 so that inboard stanchions 14 can be connected to the inboard rail 26a by sliding the elongated key 74 way recess of the inboard rail 26a over the engagement key 74 of each inboard stanchion 14, or vice versa.

The intermediate support arms 24a, 24b each include a vertically-oriented inboard stanchion receptacle 78 defined, in part, by the inboard stanchion receiving hole 38. The inboard stanchion receptacles 78 are oriented vertically through the respective inboard ends of the intermediate support arms 24a, 24b and intersect respective inboard rail receptacles 28a to form an inboard receptacle T intersection. Each inboard stanchion receptacle 78 is shaped to receive a lower end of an inboard stanchion 14 so that a joint 80 formed by the connection of each inboard stanchion 14 to the inboard rail 26a is housed within and supported by the receptacle T intersection.

The outboard stanchions 18 are disposed in a generally horizontal orientation and the outboard ends of the outboard stanchions 18 are connectable to a wall 22 or other supporting structure of the vehicle.

The intermediate support arms 24a, 24b each include a generally horizontally-oriented outboard stanchion receptacle 79 defined, in part, by the outboard stanchion receiving hole 40. The outboard stanchion receptacles 79 are oriented horizontally through the respective outboard ends of the intermediate support arms 24a, 24b and intersect respective outboard rail receptacles 28b to form outboard receptacle T intersections. Each outboard stanchion receptacle 79 is shaped to receive an inboard end of an outboard stanchion 18 so that a joint 83 formed by the connection of each outboard stanchion 18 to the outboard rail 26b is housed within and supported by the outboard receptacle T intersection.

Like the inboard stanchions, and as best shown in FIG. 4, each outboard stanchion 18 includes an engagement key 84 having a T-shaped cross-section and extending integrally and axially from the inboard end of each outboard stanchion 18. Each outboard stanchion engagement key 84 is slidably retained in an elongated keyway recess 86 formed in the outboard rail 26b. The keyway recess 86 has a cross-section complementary to that of the engagement key 84 so that outboard stanchions 18 can be connected to the outboard rail 26b by sliding the elongated keyway recess 86 of the outboard rail 26b onto the engagement keys 84 of the outboard stanchions 18, or vice versa. This also allows the outboard stanchions 18 to be slid along the outboard rail 26b to advantageous positions that allow the outboard stanchions 18 to be aligned with and attached to a vehicle wall 22 or other structure while avoiding windows and the like.

As shown in phantom in FIG. 4, the loft assembly 10 may include diagonal stanchions 88 connected at respective inboard ends to the outboard side of the rack 12. The diagonal stanchions 88 have outboard ends connectable to a vehicle wall 22 to further brace the loft assembly 10 against lateral sway.

The loft assembly 10 includes receptacles 89 in the form of stainless steel fittings configured to receive respective upper ends of the inboard stanchions 14 and outboard ends of the outboard stanchions 18. As best shown in FIGS. 4 and 6, each receptacle 89 includes a flange 90 with through holes 92 to receive fasteners that attach the receptacle 89 to a surface of the vehicle interior. Each receptacle 89 also includes two diametrically opposed receptacle holes 94 that are formed through opposite walls of the receptacle. Each stanchion 14, 18 includes a pair of diametrically opposed stanchion holes 96 formed through the upper end of each stanchion 14, 18. The stanchion holes 96 are positioned to align with the receptacle holes 92, as best shown in FIG. 6, when a stanchion is pushed into a receptacle. The stanchion and receptacle holes, when aligned, are shaped and positioned to receive the shaft of a fastener.

The inboard rail 26a of the rack 12 is elevated farther up from the plane of the intermediate rails 26c than is the outboard rail 26b. This is to provide added protection against articles falling over the inboard side 15 of the rack 12. The rack is, however, reversible such that what is shown in the drawings is the outboard rail 26b becomes the inboard rail 26a and the inboard rail 26a becomes the outboard rail 26b. When reversed, the lower rail makes it easier for passengers to place articles on the rack 12. The outboard rail 26b, while having a lower elevation than the inboard—most rack 12, has sufficient elevation above the intermediate rails 26c to meet minimum applicable safety regulations.

The rails 26 are spaced far enough apart to allow standard size cans and bottles to fall through. This prevents passengers from disposing of empty cans and bottles in the loft assembly 10 where they can be difficult for cleaning crews to reach.

The assembly 10 includes four elongated lamp modules 98, each supported on two of the adjacent intermediate rails 26c and each including two downwardly-directed lamps 100. Each lamp module 98 includes an elongated base panel 102 supporting the lamps 100, and a top panel 104 or shell supporting the base panel 102 and protecting the lamps 100 and interconnecting wiring from articles placed on the rack 12. As best shown in FIG. 5, tongue and groove arrangements 106 along opposite lateral edges of the lamp module 98 allow the base panel 102 and top panel 104 to be easily joined together. The top panel 104 is also shaped to engage and support the lamp module 98 from two adjacent rails 26 of the assembly 10. More specifically, the top panel 104 is formed to include two semi-cylindrical rail retainers configured to snap onto adjacent rails 26 of the luggage loft assembly 10.

In practice, a luggage loft assembly 10 can be assembled and installed by first assembling the loft assembly 10 such that the inboard stanchions 14 extend from respective spaced apart locations along an inboard side 15 of the rack 12 and the outboard stanchions 18 extend from respective spaced apart locations along an outboard side 20 of the rack 12. Stanchion receptacles 89 are then fixed in desired locations along the ceiling 16 or other overhead supporting structure of a vehicle as well as in desired locations along a wall 22 or other supporting structure of the vehicle. The loft assembly 10 is then moved into a desired position for installation within a vehicle, the upper ends of the inboard stanchions 14 are connected to the ceiling 16 by inserting the upper ends into the receptacles 89 fixed to the ceiling 16, and the outboard ends of the outboard stanchions 18 are connected to the wall 22 of the vehicle by inserting the outboard ends into the receptacles 89 fixed along the wall.

The rack 12 may be assembled by sliding the rails 26 through rail receptacles 28 spaced along respective lengths of the intermediate support arms 24a, 24b and the forward and aft end arms 24d, 24e. The end arms 24d, 24e are mounted at the forward and aft ends of the rails 26 and the intermediate support arms 24a, 24b are spaced between the forward and aft end arms 24d, 24e such that the arms 24 are all generally parallel to one another and carry the rails 26 in a generally parallel orientation relative to one another and perpendicular relative to the arms 24. Respective lower ends of the inboard stanchions 14 are then attached to an inboard side 15 of the rack 12 and respective inboard ends of at least two outboard stanchions 18 are attached to an outboard side 20 of the rack 12.

The inboard stanchions 14 may be attached to the inboard side 15 of the rack 12 by inserting the keyed ends 74 of the inboard stanchions 14 into the inboard stanchion receptacles 78 of assembled intermediate support arms 24a, 24b until the keyed ends 74 extend into the inboard rail receptacles 28a at the intersections of the inboard rail and stanchion receptacles 28a, 78. The inboard rail 26a is then slid through the inboard rail receptacles 28a of the intermediate support arms 24a, 24b such that the keyway recess 76 formed along the length of the inboard rail 26a receives and slides along the key 74 extending from the inboard stanchion 14.

Similarly, the outboard stanchions 18 may be attached to the outboard side 20 of the rack 12 by first inserting the keyed ends 84 of the outboard stanchions 18 into the outboard stanchion receptacles 79 of assembled intermediate support arms 24a, 24b until the keyed ends 84 extend into the outboard rail receptacles 28b at the intersections 81 of the outboard rail and stanchion receptacles 28b, 79. The outboard rail 26b is the slid through the outboard rail receptacles 28b of the intermediate support arms 24a, 24b such that the keyway recess 86 formed along the length of the outboard rail 26b receives and slides along the key 84 extending from the outboard stanchion 18.

Alternatively, the rack 12 may be assembled by initially sliding the rails 26 through the apertures 34 of just the forward panel 30 of a first one of the support arms 24a rather than a fully assembled intermediate support arm 24a, 24b. The key 74 integrally extending from an inboard end of one of the outboard stanchions 18 is then inserted into the complementary keyway recess 76 formed along the length of the outboard rail 26b and the outboard stanchion 18 is then slid along that rail and into engagement with the complementary outboard stanchion recess 36 in the forward panel 30 of the first intermediate support arm 24a.

The key 84 integrally extending from a lower end of one of the inboard stanchions 14 is then slid into the complementary keyway recess 86 formed along the length of the inboard rail 26a and the inboard stanchion 14 is slid along that rail and into engagement with the complementary inboard recess 35 in the forward panel 30 of the first intermediate support arm 24a. The apertures 34 of the aft panel 32 of the first intermediate support arm 24a are then engaged on the rails 26 and the aft support arm panel 32 is slid along the rails 26 and into engagement with the forward panel of the first intermediate support arm 24a such that intersecting portions of the inboard and outboard stanchions 14, 18 and the inboard and outboard rails 26a, 26b are enclosed within the first intermediate support arm 24a. The aft panel 32 of the first intermediate support arm 24a is then fastened to the forward panel 30 of the first intermediate support arm 24a by installing fasteners 108 in corresponding holes 110 and bosses 112 in the forward and aft support arm panels 30, 32. This same procedure is then followed with respect to a second of the support arms 24b, a second inboard stanchion 14 and a second outboard stanchion 18.

Before assembling the arms 24 on the rails 26, the vertical diametrical anti-rotation through holes 42 are formed in each of the intermediate rails 26c at respective positions along the lengths of the rails 26 where intermediate support arms 24a, 24b are to be located. An anti-rotation pin is then installed through each anti-rotation hole 42 with opposite ends of the pins 44 extending radially outward from the respective rails 26 that the pins 44 are installed in. The forward and aft panels 30, 32 of each intermediate support arm 24a, 24b are then closed around the pins 44 such that the anti-rotation recesses 46 capture the outwardly extending portions of the anti-rotation pins 44.

The forward end of a rack 12 is “capped-off” by first engaging the apertures 64 of the aft support arm panel 62 of the forward end arm 24d on the rails 26 and positioning the aft support arm panel 62 of the forward end arm 24d at respective forward distal ends of the rails 26. A flat end panel 70, having the same general shape as a lateral cross-section of the forward end arm 24d, is then positioned across a forward side of the aft support arm panel 62 and is fastened in place.

To fasten the end panel 70 in place, two rubber expansion plugs 72 are installed in the forward distal ends of two of the intermediate rails 26c before positioning the end panel 70 across the forward end arm 24d. The expansion plugs 72 are of a known variety, each having a threaded metal sleeve (not shown) embedded in a forward end of an axial hole in the plug, and each having an outer diameter generally equal to an inner diameter of the intermediate rail 26c to be engaged. After positioning the end panel 70, threaded shafts of fasteners 73 are inserted through corresponding holes in the end panel 70 and into the axial holes of the plugs 72, threadedly engaging the fasteners with the threaded sleeves embedded in the plugs 72. The fasteners 73 are then rotated such that the threaded sleeves are drawn axially aft, axially compressing the plugs 72 and providing an interference fit by causing radial pressure to be exerted against the inner walls of the rails 26.

The aft end of the rack 12 is “capped-off” by first engaging the apertures 68 of the forward support arm panel 66 of an aft end arm 24e on the rails 26 and positioning the forward support arm panel 66 of the aft end arm 24e at respective aft distal ends of the rails 26. A flat end panel, having the same general shape as a lateral cross-section of the aft end arm 24e, may then positioned across an aft side of the forward panel and is fastened in place if the aft end of the rack 12 is not to be joined to the forward end of another rack.

A pair of the loft assemblies 10 may be connected end-to-end as shown in FIGS. 2 and 7 by first engaging and positioning the apertures 68 of the forward support arm panel 66 of an aft end arm 24e on the aft distal ends of rails 26 of a forward loft assembly 10 of two loft assemblies 10, 10′ to be mounted in a forward position in a vehicle, and engaging and positioning the apertures 64 of the aft support arm panel 62 of a forward end arm 24d on the forward distal ends of rails 26 of an aft loft assembly 10′ to be mounted in an aft position in a vehicle. The forward and aft loft assemblies 10, 10′ are then mounted or positioned in respective forward and aft, end-to-end positions in a vehicle with the forward support arm panel 66 of the aft end arm 24e of the forward loft assembly 10 abutting the aft support arm panel 62 of the forward end arm 24d of the aft loft assembly 10′. The forward support arm panel 66 of the aft end arm 24e of the forward rack 12 is then fastened to the aft support arm panel 62 of the forward support arm of the aft rack 12.

This description is intended to illustrate certain embodiments of the invention rather than to limit the invention. Therefore, it uses descriptive rather than limiting words. Obviously it's possible to modify this invention from what the description teaches. As such, within the scope of the claims, one may practice the invention other than as described.

What is claimed is:

1. A luggage loft assembly for supporting articles over the seating area of a mass transit vehicle passenger compartment, the assembly comprising:
a rack configured to carry objects for storage;
at least two spaced-apart generally parallel inboard stanchions connected at respective inboard stanchion lower ends to an inboard side of the rack, the inboard stanchions having respective upper ends connectable to a vehicle ceiling;
at least two spaced-apart generally parallel outboard stanchions connected at respective outboard stanchion inboard ends to an outboard side of the rack, the outboard stanchions having respective outboard ends connectable to a vehicle structure; and
the rack including at least two spaced-apart generally parallel support arms and a plurality of generally parallel spaced-apart rails carried by the support arms to allow the contents of the loft to be viewed from below, to improve circulation of air through the passenger compartment, and to allow the loft to flex torsionally with a host vehicle.

2. A luggage loft assembly as defined in claim 1 in which the rails are cylindrical.

3. A luggage loft assembly as defined in claim 1 in which the rails are tubular.

4. A luggage loft assembly as defined in claim 1 in which the rails are made of fiberglass.

5. A luggage loft assembly as defined in claim 1 in which the inboard and outboard rails are out of plane above the intermediate rails between them to prevent articles from sliding laterally off the rack.

6. A luggage loft assembly as defined in claim 1 in which the inboard and outboard rails are extruded aluminum tubes.

7. A luggage loft assembly as defined in claim 1 in which the support arms include a plurality of rail receptacles shaped to receive the rails and position the rails relative to one another.

8. A luggage loft assembly as defined in claim 7 in which each support arm comprises forward and aft interconnecting elongated panels, each panel including a plurality of apertures positioned to align with each other and form a plurality of rail receptacles spaced along respective lengths of the support arms when the forward and aft support arm panels are interconnected.

9. A luggage loft assembly as defined in claim 8 in which the forward and aft panels of at least one of the support arms includes and inboard and an outboard recess configured and positioned to receive an inboard and an outboard stanchion, respectively.

10. A luggage loft assembly as defined in claim 8 in which:
at least one of the rails includes an anti-rotation through hole at a position along the length of the at least one rail where a support arm is to be located;
an anti-rotation pin is disposed through the anti-rotation hole, the pin having a length greater than the length of the anti-rotation hole so that at least one end of the pin extends outward from the rail in a generally radial direction;
an anti-rotation recess is formed in an aft end of a sleeve defining one of the apertures in the forward panel of at least one support arm, the recess being shaped to receive and retain an outwardly extending portion of the anti-rotation pin; and
an outwardly extending portion of the anti-rotation pin is engaged in the anti-rotation recess.

11. A luggage loft assembly as defined in claim 8 in which:
each support arm forward panel includes a front panel and a peripheral wall extending aft from around a periphery of the front panel;
each support arm aft panel includes a back panel and a peripheral wall extending aft from around a periphery of the back panel; and
an aft edge of the forward panel peripheral wall and a forward edge of the aft panel peripheral wall are configured to interlock so as to hold the edges of the walls in flush abutment and form a uniform seam between them.

12. A luggage loft assembly as defined in claim 11 in which:
the aft edge of the forward panel peripheral wall includes a beveled inner lip; and
the forward edge of the aft panel peripheral wall includes a beveled outer lip positioned to slide outside the beveled inner lip of the forward panel peripheral wall.

13. A luggage loft assembly as defined in claim 8 further including an end panel comprising:
one of a forward or an aft support arm panel having apertures engaged on respective distal ends of the rails; and
an end panel fastened across the support arm panel.

14. A luggage loft assembly as defined in claim 1 in which the inboard stanchion lower ends are connected to respective support arm inboard ends.

15. A luggage loft assembly as defined in claim 1 in which:
each inboard stanchion includes an engagement key having an inverted T-shape and extending integrally and axially from the lower end of each stanchion; and
each inboard stanchion engagement key is slidably retained in an elongated keyway recess formed in the inboard rail and has a cross section complementary to that of the engagement key such that inboard stanchions can be connected to the inboard rail by sliding the elongated keyway recess of the inboard rail over the engagement key of each inboard stanchion.

16. A luggage loft assembly as defined in claim 1 in which:
the support arms each include an inboard stanchion receptacle formed vertically through the inboard end of each arm and intersecting an inboard rail receptacle to form an inboard receptacle intersection; and
each inboard stanchion receptacle is shaped to receive a lower end of each inboard stanchion such that a joint formed by the connection of each inboard stanchion to the inboard rail is housed within the receptacle intersection.

17. A luggage loft assembly as defined in claim 1 in which:
the outboard stanchions are disposed in a generally horizontal orientation; and
the outboard ends of the outboard stanchions are connectable to a wall of the vehicle.

18. A luggage loft assembly as defined in claim 1 in which:
each outboard stanchion includes an engagement key having an inverted T-shape and extending integrally and axially from the inboard end of each outboard stanchion; and
each outboard stanchion engagement key is slidably retained in an elongated keyway recess formed in the outboard rail and has a cross section complementary to that of the engagement key.

19. A luggage loft assembly as defined in claim 1 in which the loft includes diagonal stanchions connected at respective inboard ends to the outboard end of the rack and disposed in a generally diagonal orientation relative to the inboard stanchions, the diagonal stanchions having outboard ends connectable to a vehicle wall to further brace the loft.

20. A luggage loft assembly as defined in claim 1 in which the outboard stanchions are connectable at their outboard ends to a cornice-mounted interior lighting fixture supported in a vehicle passenger compartment.

21. A luggage loft assembly as defined in claim 20 in which the outboard stanchions are connectable at their outboard ends to a portion of the cornice lighting fixture disposed outboard of a lamp of the lighting fixture.

22. A luggage loft assembly as defined in claim 20 in which the outboard stanchions are connectable at their outboard ends to a portion of the cornice lighting fixture disposed inboard of a lamp of the lighting fixture.

23. A luggage loft assembly as defined in claim 1 in which:
the loft includes receptacles configured to receive respective upper ends of the inboard stanchions and outboard ends of the outboard stanchions, each receptacle being configured to attach to a surface of a vehicle interior and including a pair of diametrically opposed receptacle holes are formed through opposite walls of the receptacle; and
each stanchion includes a pair of diametrically opposed stanchion holes formed through the upper end of each stanchion, the stanchion holes being configured to align with the receptacle holes when a stanchion is pushed into a receptacle, the stanchion and receptacle holes being configured to receive the shaft of a fastener when so aligned.

24. A luggage loft assembly as defined in claim 11 in which the inboard rail is elevated farther above the plain of the intermediate rails than is the outboard rail.

25. A luggage loft assembly as defined in claim 11 in which the outboard rail is elevated above the plain of the intermediate rails by the minimum amount required by applicable safety regulations.

26. A luggage loft assembly as defined in claim 1 in which the rails are spaced far enough apart to allow standard sized cans and bottles to fall through between the rails.

27. A luggage loft assembly as defined in claim 1 further including an elongated lamp module supportable on any two adjacent rails of the assembly and including at least one downwardly-directed lamp.

28. A luggage loft assembly as defined in claim 27 in which each lamp module includes:
a base panel supporting the at least one lamp; and
a top panel supporting the base panel and configured to engage and support the lamp module from two adjacent rails of the assembly.

29. A luggage loft assembly as defined in claim 28 in which the top panel is formed to include two rail retainers configured to snap onto adjacent rails of the luggage loft assembly.

30. A method for making and installing a luggage loft assembly comprising a rack comprising at least two inboard stanchions connectable at respective lower ends to an inboard side of the rack and at respective upper ends to a vehicle ceiling; and at least two outboard stanchions connectable at respective inboard ends to an outboard side of the rack and at respective outboard ends to a vehicle structure; the method including the steps of:
assembling the loft assembly such that the inboard stanchions extend from respective spaced apart locations along an inboard side of the rack and the outboard stanchions extend from respective spaced apart locations along an outboard side of the rack;
affixing inboard stanchion receptacles in desired locations along the ceiling of a vehicle;
affixing outboard stanchion receptacles in desired locations along a wall or other supporting structure of the vehicle;
moving the loft assembly into a desired position for installation within a vehicle;
connecting upper ends of the inboard stanchions to the inboard receptacles; and
connecting outboard ends of the outboard stanchions to the outboard receptacles.

31. A method for making a luggage loft assembly, the method including the steps of:
assembling a rack by:
providing a plurality of rails and at least two elongated support arms configured to carry the rails,
sliding the rails through rail receptacles spaced along respective lengths of the support arms, and
spacing the support arms such that the arms are generally parallel to one another and carry the rails in a generally parallel orientation relative to one another and perpendicular relative to the arms;
attaching respective lower ends of at least two inboard stanchions to an inboard side of the rack; and
attaching respective inboard ends of at least two outboard stanchions to an outboard side of the rack.

32. The method of claim 31 in which the step of attaching inboard stanchions includes:
inserting a keyed end of an inboard stanchion into a vertical receptacle of one of the support arms that intersects one of the rail receptacles of that support arm such that a key extending from the inboard stanchion is positioned within the rail receptacle; and
sliding a rail through the intersecting rail receptacle of the support arm such that a keyway recess formed along the length of the rail receives and slides along the key extending from the inboard stanchion.

33. The method of claim 30 in which the step of attaching outboard stanchions includes:
inserting a keyed end of an outboard stanchion into an outboard stanchion receptacle of one of the support arms that intersects one of the rail receptacles of that support arm such that a key extending from the outboard stanchion is positioned within the rail receptacle; and
sliding a rail through the intersecting rail receptacle of the support arm such that a keyway recess formed along the length of the rail receives and slides along the key extending from the outboard stanchion.

34. The method of claim 30 including the additional steps of:
providing a plurality of rails and two elongated support arms configured to carry the rails, each support arm comprising forward and aft interconnecting elongated panels, each panel including a plurality of apertures positioned to align with each other and form a plurality of rail receptacles spaced along respective lengths of the support arms when the forward and aft support arm panels are interconnected;
sliding the rails through the apertures of the forward panel of a first one of the support arms;
inserting a key integrally extending from an inboard end of one of the outboard stanchions into a complementary keyway recess formed along the length of one of the rails and sliding the outboard stanchion along that rail and into engagement with the forward panel of the first support arm;
inserting a key integrally extending from a lower end of one of the inboard stanchions into a complementary keyway recess formed along the length of one of the rails and sliding the inboard stanchion along that rail and into engagement with the forward panel of the first support arm;
engaging the apertures of the aft panel of the first support arm on the rails and sliding it along the rails and into engagement with the forward panel of the first support arm such that intersecting portions of the stanchions and rails are enclosed within the first support arm; and
connecting the aft panel of the first support arm the forward panel of the first support arm.

35. The method of claim 34 including the additional steps of:
providing an anti-rotation through hole in one of the rails at a position along the length of that rail where a support arm is to be located;
passing an anti-rotation pin through the anti-rotation hole, the pin having a length greater than the length of the anti-rotation hole so that at least one end of the pin extends outward from the rail in a generally radial direction;
providing an anti-rotation recess in an aft end of a sleeve defining one of the apertures in the forward panel of the first support arm, the recess being shaped to receive and retain an outwardly extending portion of the anti-rotation pin; and
engaging an outwardly extending portion of the anti-rotation pin in the anti-rotation recess during the step of sliding the rails through the apertures of the forward panel of the first support arm.

36. The method of claim 34 including the additional steps of:
engaging the apertures of the forward panel of a second support arm on the rails;
positioning the forward panel of the second support arm at respective aft distal ends of the rails;
positioning an end panel across an aft side of the forward panel; and
fastening the end panel to the forward panel.

37. The method of claim 36 including the additional steps of:
before the step of positioning an end panel, inserting an expansion plug into the distal end of one of the rails, the expansion plug having a threaded sleeve embedded in a forward end of an axial hole in the plug, the expansion plug having an outer diameter generally equal to an inner diameter of the rail;
after the step of positioning an end panel, inserting a threaded shaft of a fastener through a hole in the end panel and into the axial hole of the plug, threadedly engaging the fastener with the threaded sleeve of the plug; and
rotating the fastener about its axis such that the threaded sleeve is drawn axially aft, axially compressing the plug and causing radial pressure against an inner wall of the rail.

38. A method for interconnecting end-to-end a pair of loft assembly racks for a mass transit vehicle passenger compartment, each rack comprising a plurality of rails carried by two elongated support arms, each support arm comprising forward and aft interconnecting elongated panels, each panel including a plurality of apertures positioned to align with each other and form a plurality of rail receptacles spaced along respective lengths of the support arms when the forward and aft support arm panels are interconnected; the method including the steps of:
engaging and positioning the apertures of a support arm forward panel on the aft distal ends of rails of a forward one of the two racks;
engaging and positioning the apertures of a support arm aft panel on the forward distal ends of rails of an aft one of the two racks;
mounting the forward and aft racks in respective forward and aft positions in a vehicle with the support arm forward panel at the aft end of the forward rack abutting the support arm aft panel at the forward end of the aft rack; and
fastening the support arm forward panel at the aft end of the forward rack to the support arm aft panel at the forward end of the aft rack.
